(19) United States
(12) Patent Application Publication
(10) Pub. No.: US 2017/0344333 A1
(43) Pub. Date: Nov. 30, 2017

(54) SCREEN CONTROLLING METHOD AND ELECTRONIC DEVICE FOR SUPPORTING THE SAME

(71) Applicant: Samsung Electronics Co., Ltd., Gyeonggi-do (KR)

(72) Inventors: Hong Ik Jin, Suwon-si (KR); Yong Soo Kwon, Suwon-si (KR); Young Kyu Seon, Yongin-si (KR); Yoo Jin Lee, Suwon-si (KR); Yu Min Cho, Seoul (KR); Se Hwan Choi, Suwon-si (KR); Kyung Jung Kim, Suwon-si (KR); Ga Jin Song, Anyang-si (KR)

(21) Appl. No.: 15/604,483

(22) Filed: May 24, 2017

(30) Foreign Application Priority Data
May 24, 2016 (KR) 10-2016-0063170

(51) Int. Cl. G06F 3/14; G06F 3/0484

(52) U.S. Cl. CPC G06F 3/1454; G06F 3/04845; G06F 2203/04803

(57) ABSTRACT

An electronic device includes a memory configured to store an application including a plurality of resources, each of the resources is matched to each of a plurality of characteristic information which include a first characteristic information of the electronic device and a second characteristic information of an external electronic device. A communication interface communicates with the external electronic device and a processor is operatively connected with the memory and the communication interface. The processor receives the second characteristic information of the external electronic device connected via the communication interface, selects at least one of the resources included in the application based on the second characteristic information of the external electronic device, generates a screen where the application is executed, using the at least one of the resources, and transmits data corresponding to the screen to the external electronic device.

### CROSS-REFERENCE TO RELATED APPLICATION(S) AND CLAIM OF PRIORITY

The present application is related to and claims the benefit under 35 U.S.C. §119(a) of a Korean patent application filed on May 24, 2016 in the Korean Intellectual Property Office and assigned Serial number 10-2016-0063170, the entire disclosure of which is hereby incorporated by reference.

### TECHNICAL FIELD

The present disclosure relates to a screen control method and an electronic device for supporting the same.

### BACKGROUND

An electronic device such as a smartphone may provide a communication service with an external electronic device. For example, the electronic device may provide a communication service with a mouse, a keyboard, a display device, a printer, a camera, a television (TV), or the like. As an example, the electronic device may be connected with the TV through wired/wireless communication and may support to output an application executed in the electronic device on the TV. As another example, the electronic device may be connected with a display device connected to a dashboard of a vehicle, through wired/wireless communication and may support to output an application executed in the electronic device on the display device.

In this regard, the electronic device may use mirroring or a connected communication link to output a screen where an application executed in the electronic device is executed on an external electronic device. For example, the electronic device may support to output a screen where an application is executed on the external electronic device by executing the application installed in the electronic device and transmitting data corresponding to the screen where the application is executed to the external electronic device using the mirroring or the communication link. In this case, the electronic device may configure the screen where the application is executed using resources matched to characteristics of the electronic device, for example, a size of a display included in the electronic device, resolution of the display, a display direction of the display, an input processing mode of the display, or the like among resources (e.g., an image file) included in the application.

However, if the screen where the application is executed, configured using resources matched to the characteristics of the electronic device, is output on the external electronic device having characteristics different from the characteristics of the electronic device, the screen where the application is executed may be output without being matched to the characteristics of the external electronic device. For example, a screen which is not matched to a size of a display included in the external electronic device, resolution of the display, a display direction of the display, an input processing mode of the display, or the like may be output.

### SUMMARY

To address the above-discussed deficiencies, it is a primary object to provide at least the advantages described below. Accordingly, an aspect of the present disclosure is to provide a screen control method for configuring a screen where an application executed in an electronic device is executed, using at least one resource selected based on characteristic information of an external electronic device connected with the electronic device via a communication interface and supporting to output the screen where the application is executed on the external electronic device and an electronic device for supporting the same.

In accordance with an aspect of the present disclosure, an electronic device includes a memory configured to store an application including a plurality of resources, each of the resources is matched to each of a plurality of characteristic information which include a first characteristic information of the electronic device and a second characteristic information of an external electronic device, a communication interface configured to communicate with the external electronic device, and a processor configured to be operatively connected with the memory and the communication interface. The processor is configured to obtain the second characteristic information of the external electronic device connected via the communication interface, select at least one of the resources included in the application based on the second characteristic information of the external electronic device, generate a screen where the application is executed, using the at least one of the resources, and transmit data corresponding to the screen to the external electronic device.

In accordance with another aspect of the present disclosure, a method for controlling a screen of an electronic device including an application including a plurality of resources, each of the resources is matched to each of a plurality of characteristic information which include a first characteristic information of the electronic device and a second characteristic information of an external electronic device, the method includes obtaining the second characteristic information of the external electronic device connected to the electronic device, selecting at least one of the resources included in the application based on the second characteristic information of the external electronic device, generating a screen where the application is executed, using the at least one of the resources, and transmitting data corresponding to the screen to the external electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of an electronic device associated with screen control according to an embodiment.

FIG. 2 illustrates a screen control platform according to an embodiment.

FIG. 3 illustrates a method for obtaining part of characteristic information of an external electronic device according to an embodiment.

FIG. 4 illustrates an operation method of an electronic device associated with screen control according to an embodiment.

FIG. 5 illustrates a first connection form with an external electronic device according to an embodiment.

FIG. 6 illustrates a second connection form with an external electronic device according to an embodiment.

FIG. 7 illustrates illustrating a process of transmitting and receiving data with a docking device according to an embodiment.

FIG. 8 illustrates a method for outputting a screen where an application with a specified display direction is executed, according to an embodiment.

FIG. 9 illustrates a method for outputting a screen where a plurality of applications are executed, according to an embodiment.

FIG. 10 illustrates another method for outputting a screen where a plurality of applications are executed, according to an embodiment.

Throughout the drawings, it should be noted that like reference numbers are used to depict the same or similar elements, features, and structures.

### DETAILED DESCRIPTION

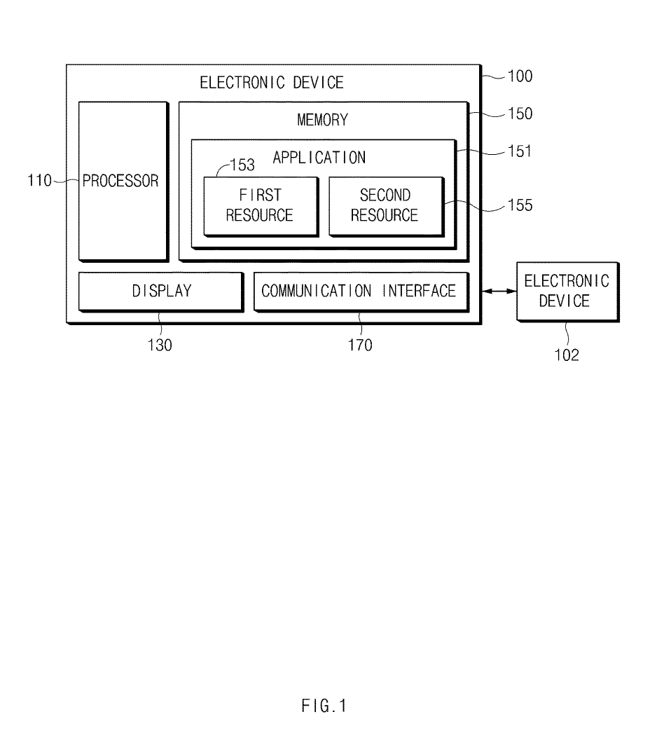

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSyncTM, Apple TVTM, or Google TVTM), a game console (e.g., XboxTM or PlayStationTM), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

FIG. 1 illustrates a configuration of an electronic device associated with screen control according to an embodiment. According to various embodiments, an electronic device 100 may support to output a screen where an application 151 executed in the electronic device 100 is executed on an external electronic device 102 connected with the electronic device 100 via a communication interface 170. For example, the electronic device 100 may support to output the screen where the application 151 is executed on a display included in the external electronic device 102 by transmitting data corresponding to the screen where the application 151 is executed to the external electronic device 102 using mirroring or a communication link. In this case, the electronic device 100 may configure the screen where the application 151 is executed to output the screen where the application 151 is executed to fit a characteristic of the external electronic device 102. According to an embodiment, the electronic device 100 may select at least one resource used by the application 151 based on characteristic information of the external electronic device 102, for example, a size (e.g., a transverse or longitudinal size) of the display included in the external electronic device 102, resolution of the display, a display direction (e.g., a landscape or portrait direction) of the display, an input processing mode (e.g., whether to support a touch interface), location information of the external electronic device 102, or the like and may configure a screen where the application 151 is executed, using the at least one selected resource.

Referring to FIG. 1, supporting the above-mentioned functions, the electronic device 100 may include a processor 110, a display 130, a memory 150, and a communication interface 170. However, the elements of the electronic device 100 are not limited thereto. According to various embodiments, at least one of the above-mentioned elements may be omitted from the electronic device 100, and at least another element may be further included in the electronic device 100. For example, the electronic device 100 may further include an input/output interface. The input/output interface may transmit instructions or data, input from a user or the external electronic device 102, to another element (other elements) of the electronic device 100 or may output instructions or data, received from another element (other elements) of the electronic device 100, to the user or the external electronic device 102.

The processor 110 may include one or more of a central processing unit (CPU), an application processor (AP), or a communication processor (CP). For example, the processor 110 may perform an arithmetic operation or data processing associated with control and/or communication of at least another element of the electronic device 100.

According to an embodiment, the processor 110 may execute the application 151. If a request to execute the application 151 occurs, the processor 110 may verify and provide an environment for executing the application 151, for example, a spare area of the memory 150. If the environment for executing the application 151 is provided, the processor 110 may verify information for installing the application 151 and may assign a code for executing the application 151 (e.g., instructions included in the application 151) and at least one resource (e.g., a first resource 153 or a second resource 155) used by the application 151 to the memory 150. Further, the processor 110 may call and operate the code and the at least one resource assigned to the memory 150 according to a program routine. As an example, the processor 110 may configure a screen where the application 151 is executed using the at least one resource and may output the screen where the application 151 is executed on the display 130.

According to an embodiment, the processor 110 may support to output a screen where the application 151 is executed on the external electronic device 102 connected with the electronic device 100 via the communication interface 170. For example, the processor 110 may control the communication interface 170 to transmit data corresponding to the screen where the application 151 is executed to the external electronic device 102. The processor 110 may configure a screen where the application 151 is executed, based on characteristic information of the external electronic device 102 to output the screen where the application 151 is executed to fit a characteristic of the external electronic device 102. For example, the processor 110 may obtain the characteristic information of the external electronic device 102 via the communication interface 170 from the external electronic device 102 and may select at least one resource to be used by the application 151 based on the obtained characteristic information of the external electronic device 102, thus configuring the screen where the application 151 is executed. The characteristic information of the external electronic device 102 may include a size of the display included in the external electronic device 102, resolution of the display, a display direction of the display, an input processing mode of the display, location information of the external electronic device 102, or the like. In this regard, a method for configuring the screen where the application 151 is executed based on the characteristic information of the external electronic device 102 will be described in detail with reference to embodiments described below.

According to an embodiment, the processor 110 may store connection history information of the external electronic device 102 in the memory 150. If the external electronic device 102 is connected to the electronic device 100 via the communication interface 170, the processor 110 may store an identifier of the external electronic device 102, a connection start time of the external electronic device 102, a connection end time of the external electronic device 102, or the like in the memory 150. Further, the processor 110 may store the characteristic information of the external electronic device 102, obtained from the external electronic device 102, together with the connection history information of the external electronic device 102 in the memory 150. Therefore, if the external electronic device 102 connected to the electronic device 100 once or more is connected to the electronic device 100 again, the processor 110 may omit a process of obtaining the characteristic information of the external electronic device 102 from the external electronic device 102 and may use the characteristic information of the external electronic device 102, stored in the memory 150.

The display 130 may include, for example, a liquid crystal display (LCD), a light-emitting diode (LED) display, an organic LED (OLED) display, a microelectromechanical systems (MEMS) display, or an electronic paper display. The display 130 may display, for example, a variety of content (e.g., a text, an image, a video, an icon, and/or a symbol) to a user. For example, the display 130 may output a screen where the application 151 is executed. The display 130 may include a touch screen and may receive, for example, a touch, gesture, proximity, or hovering input using an electronic pen or part of a user's body.

The memory 150 may include a volatile and/or non-volatile memory. The memory 150 may store instructions or data associated with at least another element of the electronic device 100. According to an embodiment, the memory 150 may store software and/or a program. The program may include the application 151. The application 151 may be a program written to perform a specified function and may be packaged and distributed together with at least one resource (e.g., the first resource 153 or the second resource 155). The at least one resource included in the application 151 may include content (e.g., an image) or layout information. The layout information may include layout information of the content displayed on a screen of the display 130.

According to an embodiment, the application 151 may include a variety of resources which may be selectively used for each characteristic of the electronic device 100. For example, the application 151 may include various resources which may be selectively used according to a size of a display included in an electronic device (e.g., the electronic device 100 or the external electronic device 102), on which a screen where the application 151 is executed will be output, resolution of the display, a display direction of the display, an input processing mode of the display, location information of the electronic device, or the like.

The application 151 may be installed in the electronic device 100 through various paths. For example, the application 151 may include a preloaded application or a third party application downloadable from the external electronic device 102 (e.g., an application download server).

According to an embodiment, the memory 150 may include a graphic memory (or a frame buffer). The graphic memory may store data for being output on the display 130 (e.g., data corresponding to a screen where the application 151 is executed).

According to an embodiment, the memory 150 may store connection history information of the external electronic device 102. Further, the memory 150 may store characteristic information of the external electronic device 102. In this case, the memory 150 may map the connection history information of the external electronic device 102 with characteristic information of the external electronic device 102 to store the mapped information.

The communication interface 170 may establish communication between the electronic device 100 and the external electronic device 102. For example, the communication interface 170 may connect to a network through wireless communication or wired communication to communicate with the external electronic device 102.

According to an embodiment, the communication interface 170 may collect location information of the electronic device 100 through a global navigation satellite system (GNSS). The GNSS may be, for example, a global positioning system (GPS), a global navigation satellite system (GLONASS), a Beidou navigation satellite system (hereinafter referred to as “BEIDOU”), or an European global satellite-based navigation system (hereinafter referred to as “GALILEO”). Hereinafter, in this disclosure, “GPS” and “GNSS” may be interchangeably used.

The external electronic device 102 may be a device of which the type is different from or the same as that of the electronic device 100. According to various embodiments, all or some of operations executed by the electronic device 100 may be executed by the external electronic device 102. According to an embodiment, in the case where the electronic device 100 executes any function or service automatically or in response to a request, the electronic device 100 may fail to perform the function or the service internally, but, alternatively or additionally, it may request the external electronic device 102 to perform at least part of a function associated with the electronic device 100. The external electronic device 102 may execute the requested function or additional function and may transmit the executed result to the electronic device 100. The electronic device 100 may provide the requested function or service using the received result or may additionally process the received result to provide the requested function or service. To this end, for example, cloud computing, distributed computing, or client-server computing may be used.

According to an embodiment, if outputting a screen where the application 151 executed in the electronic device 100 is executed, the external electronic device 102 may output data corresponding to the screen where the application 151, obtained from the electronic device 100, without change or may transform part of data to output the transformed data. In some embodiments, the external electronic device 102 may obtain at least one resource selected based on a code for executing the application 151 and characteristic information of the external electronic device 102, rather than obtaining data corresponding to a screen where the application 151 is executed from the electronic device 100. In this case, the external electronic device 102 may call and operate the code for executing the application 151 and the at least one resource according to a program routine, itself or by a request of the electronic device 100.

According to various embodiments, the electronic device 100 may be connected with an external input device (e.g., a Bluetooth keyboard). For example, the electronic device 100 may be connected with the external input device through wired/wireless communication based on the communication interface 170. According to an embodiment, the electronic device 100 may provide an input interface to the user by outputting a soft input panel (SIP), which supports a user input, on the display 130. However, if the electronic device 100 is connected with the external input device, it may receive an input from the user via the external input device, rather than outputting the SIP on the display 130. According to an embodiment, if the external input device is connected to the electronic device 100 in a state where the SIP is output, the electronic device 100 may end the output of the SIP.

According to various embodiments, if a user input does not occur during a specified time or more, the external input device may perform a specified function (e.g., a sleep function). For example, if the external input device is not used during a specified time, it may be changed to a sleep state. If the external input device is changed to the sleep state, the electronic device 100 may determine that the connection with the external input device is ended. However, since the user explicitly disconnects the electronic device 100 from the external input device if the external device is changed to the sleep state, if a user input occurs on the external input device, the external input device may be connected with the electronic device 100 again without inquiring of the user about whether to connect to the electronic device 100. In this case, the electronic device 100 may receive a user input via the external input device without outputting the SIP. In other words, if a disconnection of the external input device is not explicitly performed based on a request by the user, the electronic device 100 may fail to output the SIP. According to an embodiment, the electronic device 100 may output a display object (e.g., a pop-up object), for providing notification that there is an available external input device, on the display 130 to guide the user to use the external input device.

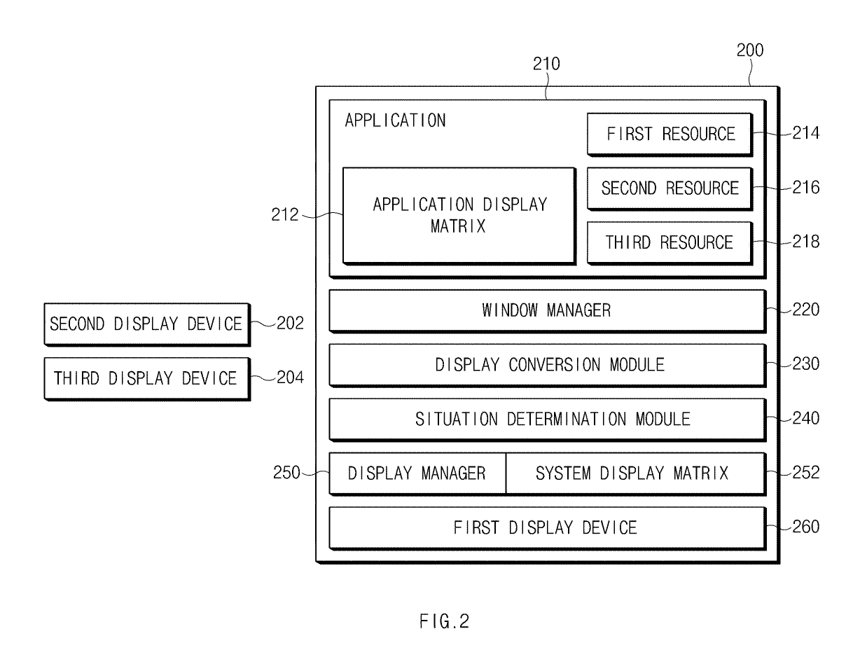

FIG. 2 illustrates a screen control platform according to an embodiment. According to various embodiments, a screen control platform 200 may be all or part of an electronic device 100 shown in FIG. 1 and may be an architecture indicating an association of functions for screen control (or elements of the electronic device 100). According to an embodiment, all or part of the screen control platform 200 may be included in a platform (or an operating system (OS)) supported by the electronic device 100 or may be configured as a service application to operate.

Referring to FIG. 2, the screen control platform 200 may include an application 210, a window manager 220, a display conversion module 230, a situation determination module 240, a display manager 250, and a first display device 260. However, the elements of the screen control platform 200 are not limited thereto. According to various embodiments, at least one of the above-mentioned elements may be omitted from the screen control platform 200, and at least another element may be further included in the screen control platform 200.

The application 210 may include the same or similar elements to those of an application 151 of FIG. 1. The application 210 may be a program written to perform a specified function. The application 210 may include an application display matrix 212, a first resource 214, a second resource 216, and a third resource 218. However, the number of the resources included in the application 210 is not limited thereto. According to various embodiments, at least one of the above-mentioned resources may be omitted from the application 210, and at least another resource may be further included in the application 210.

The application display matrix 212 may include information for configuring a screen where the application 210 is executed. For example, the application display matrix 212 may include information for configuring a user interface supported through the application 210, in a process where the application 210 is executed. According to an embodiment, the application display matrix 212 may include a size of a display (e.g., the first display device 260, a second display device 202, or a third display device 204) on which a screen where the application 210 is executed will be output, resolution of the display, a display direction of the display, an input processing mode of the display (e.g., whether to support a touch interface), location information of an electronic device including the display, or the like.

The window manager 220 may manage a graphic user interface (GUI) resource used in a screen of the display. According to an embodiment, the window manager 220 may assign (or store) data corresponding to a screen where the application 210 is executed to (or in) a graphic memory which stores data to be output on the display. When assigning the data corresponding to the screen where the application 210 is executed, the window manager 220 may configure the screen where the application 210 is executed, using at least one resource to be used by the application 210, selected based on the application display matrix 212. As another example, the window manager 220 may set information of a touch region for a touch input which will occur on a screen where the application 210 is executed, depending on whether to support a touch interface included in the application display matrix 212. Further, the window manager 220 may map the set information of the touch region to data corresponding to the screen where the application 210 is executed, assigned to the graphic memory.

Therefore, the display (e.g., the first display device 260, the second display device 202, or the third display device 204) to output the screen where the application 210 is executed may output the screen where the application 210 is executed, using data stored in the graphic memory. Although not illustrated, if the display to output the screen where the application 210 is executed is the display (e.g., the second display device 202 or the third display device 204) included in an external electronic device 102 of FIG. 1, the screen control platform 200 may transmit data stored in the graphic memory to the external electronic device 102 via a communication interface 170 of FIG. 1.

The display conversion module 230 may update the application display matrix 212 based on characteristic information of the display (e.g., the first display device 260, the second display device 202, or the third display device 204), obtained via the situation determination module 240. For example, the display conversion module 230 may update the application display matrix 212 based on a size of a display to output a screen where the application 210 is executed, resolution of the display, a display direction of the display, an input processing mode of the display, location information of an electronic device including the display, or the like, obtained via the situation determination module 240.

According to an embodiment, the display conversion module 230 may select at least one resource to be used by the application 210. As an example, the display conversion module 230 may select at least one resource to be used by the application 210 among resources included in the application 210 based on characteristic information of the display (e.g., the first display device 260, the second display device 202, or the third display device 204), obtained via the situation determination module 240. Further, the display conversion module 230 may store information about the selected resource in the application display matrix 212.

According to an embodiment, the display conversion module 230 may determine whether to output a screen where the application 210 is executed in a landscape or portrait direction and may transmit the determined result to the application display matrix 212. As an example, the display conversion module 230 may compare a transverse size of the display to output a screen where the application 210 is executed with a longitudinal size of the display and may determine a display direction of the screen where the application 210 is executed. As another example, the display conversion module 230 may verify layout information included in the application 210 to determine a display direction supported by the application 210 and may determine a display direction of a screen where the application 210 is executed as the display direction supported by the application 210.

According to an embodiment, if the application 210 which supports a specified display direction is executed, the display conversion module 230 may determine whether to use a screen region which may remain after a screen where the application is executed is output and may transmit the determined result to the application display matrix 212. As an example, if the application 210 which supports a portrait direction is executed, the display conversion module 230 may change at least one of size information of the display and resolution information of the display, included in the application display matrix 212, to use left and right screen regions which may remain after a screen where the application 210 is executed. As another example, if the application 210 which supports a landscape direction is executed, the display conversion module 230 may change at least one of size information of the display and resolution information of the display, included in the application display matrix 212, to use upper and lower screen regions which may remain after a screen where the application 210 is executed is output.

According to an embodiment, the display conversion module 230 may store execution state information of applications executed in an electronic device 100 of FIG. 1 in the application display matrix 212. As an example, the display conversion module 230 may determine whether a plurality of applications executed in the electronic device 100 are being executed in the foreground state or the background state and may store information about the state in the application display matrix 212. As another example, the display conversion module 230 may determine whether a plurality of applications output on a screen through a multi-window function are in an activated state (e.g., a state where the plurality of applications occupy user interface resources) or an inactivated state and may store information about the state in the application display matrix 212.

The situation determination module 240 may obtain characteristic information of the display (e.g., the first display device 260, the second display device 202, or the third display device 204) to output a screen where the application 210 is executed. As an example, if the external electronic device 102 is not connected to the electronic device 100, the situation determination module 240 may obtain a size of the display (e.g., the first display device 260) included in the electronic device 100, resolution of the display, a display direction of the display, an input processing mode of the display, location information of the electronic device 100, or the like. According to an embodiment, the situation determination module 240 may obtain characteristic information of the electronic device 100 based on the system display matrix 252. In some embodiments, the situation determination module 240 may obtain location information of the electronic device 100 among characteristic information of the electronic device 100 based on the communication interface 170. For another example, if the external electronic device 102 is connected to the electronic device 100, the situation determination module 240 may obtain a size of a display (e.g., the second display device 202 or the third display device 204) included in the external electronic device 102, resolution of the display, a display direction of the display, an input processing mode of the display, location information of the external electronic device 102, or the like. According to an embodiment, the situation determination module 240 may obtain characteristic information of the external electronic device 102 via the communication interface 170 from the external electronic device 102.

According to an embodiment, the situation determination module 240 may determine a location (e.g., a home, an office, or the like) of an electronic device (e.g., the electronic device 100 or the external electronic device 102) including a display to output a screen where the application 210 is executed. Further, the situation determination module 240 may store characteristic information and connection history information of the external electronic device 102 connected with the electronic device 100 in a memory 150 of FIG. 1. Thus, the situation determination module 240 may obtain characteristic information of the external electronic device 102 based on connection history information of the external electronic device 102, stored in the memory 150, rather than obtaining the characteristic information of the external electronic device 102 via the communication interface 170 from the external electronic device 102.

When the electronic device 100 is booted, the display manager 250 may obtain specifications (e.g., a size, resolution, a display direction, an input processing mode, or the like) of the display or configuration information from the display (e.g., the first display device 260) included in the electronic device 100. Further, the display manager 250 may configure the system display matrix 252 based on the obtained specifications or configuration information of the display. The display manager 250 may transmit specifications or configuration information of the display, included in the system display matrix 252, to the window manager 220 by a request of the window manager 220. In some embodiments, the display manager 250 may transmit location information of the electronic device 100 to the window manager 220.

The system display matrix 252 may include specifications or configuration information of the display (e.g., the first display device 260) included in the electronic device 100. For example, the system display matrix 252 may include a size, resolution, a display direction, an input processing mode, or the like of the first display device 260.

The first display device 260 may include the same or similar elements to a display 130 of FIG. 1. The second display device 202 and the third display device 204 may be included in the external electronic device 102. At least one of the first display device 260, the second display device 202, and the third display device 204 may output a screen where the application 210 is executed. As an example, the screen control platform 200 may support to output a screen where the application 210 is executed on at least one of the second display device 202 and the third display device 204 while outputting the screen where the application 210 is executed on the first display device 260. As another example, the screen control platform 200 may end the output of the first display device 260 and may support to output a screen where the application is executed on at least one of the second display device 202 and the third display device 204.

According to various embodiments, some of the elements included in the screen control platform 200 may be provided in the form of being included in a processor 110 shown in FIG. 1. Alternatively, functions of some of the elements included in the screen control platform 200 may be performed by the processor 110.

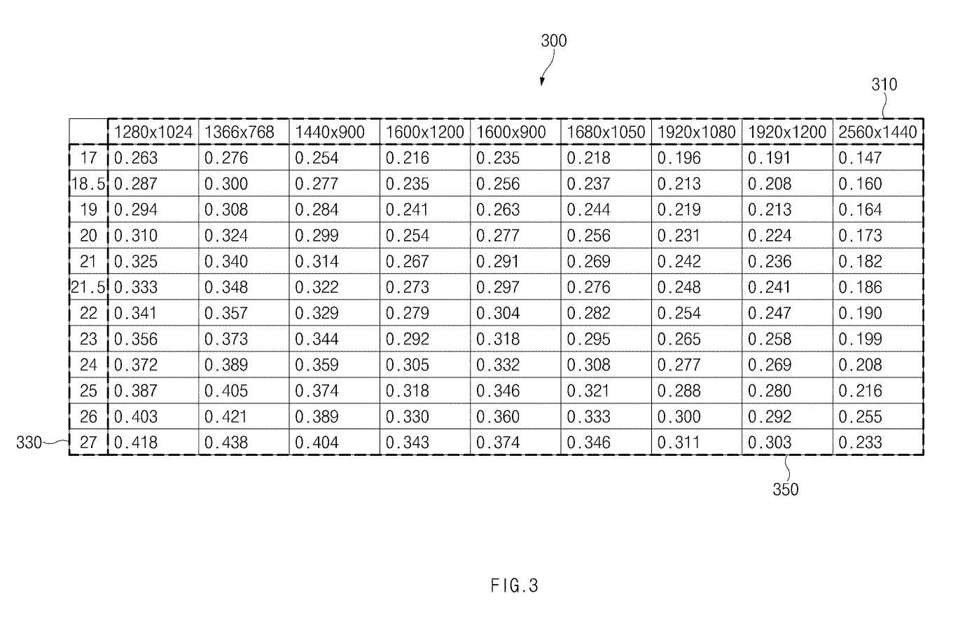

FIG. 3 illustrates a method for obtaining part of characteristic information of an external electronic device according to an embodiment.

According to various embodiments, an electronic device (e.g., an electronic device 100 of FIG. 1) may support to output a screen where an application (e.g., an application 151 of FIG. 1) executed in the electronic device is executed on an external electronic device (e.g., an external electronic device 102 of FIG. 1). For example, the electronic device may support to output a screen where the application is executed on the external electronic device by transmitting data corresponding to the screen where the application is executed to the external electronic device. In this case, the electronic device may configure a screen where the application is executed, based on characteristic information of the external electronic device. For example, the electronic device may configure a screen where the application is executed, based on a size of a display included in the external electronic device, resolution of the display, a display direction of the display, an input processing mode of the display, location information of the external electronic device, or the like.

According to an embodiment, the electronic device may obtain characteristic information of the external electronic device from the external electronic device based on a communication interface (e.g., a communication interface 170 of FIG. 1). For example, the electronic device may obtain a size of the display included in the external electronic device, resolution of the display, a display direction of the display, an input processing mode of the display, location information of the external electronic device, or the like from the external electronic device.

In some embodiments, the electronic device may obtain part of characteristic information of the external electronic device from the external electronic device. In this case, the electronic device may determine the other characteristic information of the external electronic device using a characteristic table 300 and the like of the display. For example, the electronic device may obtain a diagonal length of the display and the number of pixels located on a diagonal from the external electronic device. In this case, the electronic device may calculate a pixel pitch by dividing the diagonal length of the display by the number of the pixels on the diagonal. Further, the electronic device may ascertain a size and resolution of the display based on the calculated pixel pitch.

The characteristic table 300 of the display shown in FIG. 3 may indicate resolution 310 of the display and a pixel pitch 350 of the display depending on a size 330 (e.g., a monitor inch) of the display. The electronic device may verify the characteristic table 300 of the display and may ascertain the resolution 310 of the display and the size 330 of the display, corresponding to the calculated pixel pitch 350 of the display. According to an embodiment, the electronic device may store the characteristic table 300 of the display in a memory (e.g., a memory 150 of FIG. 1).

According to an embodiment, the electronic device may determine a size, resolution, or the like of the display included in the external electronic device, based on an identifier (e.g., a model name or the like) of the external electronic device. The electronic device may determine characteristic information of the external electronic device based on user configuration information. For example, since it is difficult for the external electronic device, such as a projector or a virtual reality (VR) device, to verify a size and resolution of the display, the electronic device may determine the size or resolution of the display based on the user configuration information. According to another embodiment, the electronic device may determine a size of the display based on resolution of the display. In some embodiments, the electronic device may obtain characteristic information of the external electronic device from a server device which manages characteristic information of the external electronic device.

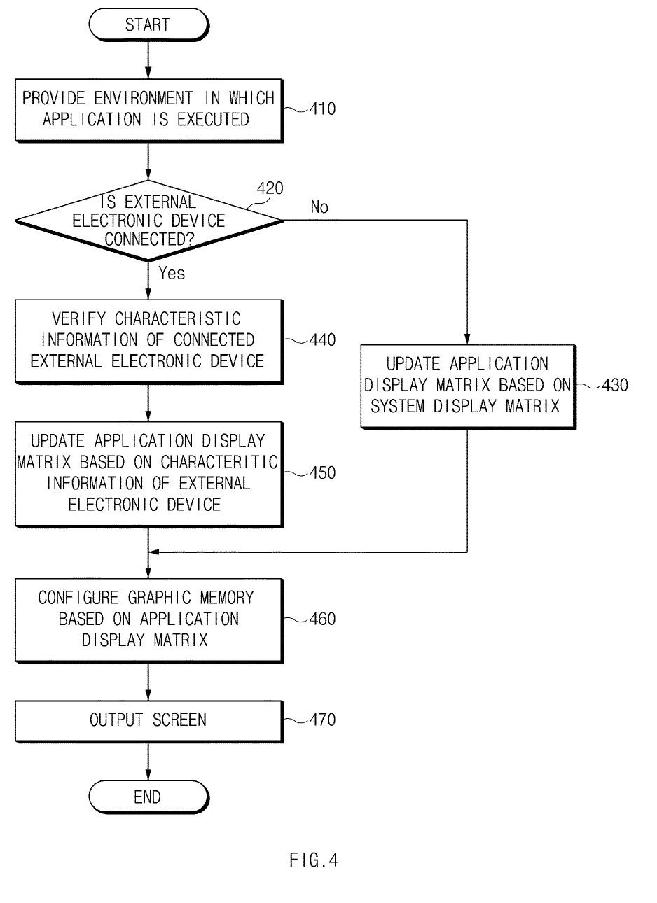

FIG. 4 illustrates an operation method of an electronic device associated with screen control according to an embodiment.

Referring to FIG. 4, in operation 410, an electronic device (e.g., an electronic device 100 of FIG. 1) may provide an environment for executing an application (e.g., an application 151 of FIG. 1). According to an embodiment, the electronic device may verify and provide a spare area of a memory (e.g., a memory 150 of FIG. 1). Further, the electronic device may verify information for installing the application.

In operation 420, the electronic device may determine whether an external electronic device (e.g., an external electronic device 102 of FIG. 1) is connected to the electronic device. According to an embodiment, the electronic device may determine whether there is the external electronic device connected via a communication interface (e.g., a communication interface 170 of FIG. 1).

If the external electronic device is not connected to the electronic device, in operation 430, the electronic device may update an application display matrix (e.g., an application display matrix 212 of FIG. 2) based on a system display matrix (e.g., a system display matrix 252 of FIG. 2).

If the external electronic device is connected to the electronic device, in operation 440, the electronic device may verify characteristic information of the connected external electronic device. According to an embodiment, the electronic device may obtain characteristic information of the external electronic device from the external electronic device. For example, the electronic device may obtain a size of a display included in the external electronic device, resolution of the display, a display direction of the display, an input processing mode of the display, location information of the external electronic device, or the like from the external electronic device. Further, in operation 450, the electronic device may update the application display matrix based on the characteristic information of the external electronic device.

In operation 460, the electronic device may configure a graphic memory based on the application display matrix. According to an embodiment, the electronic device may select at least one resource to be used by the application, based on the application display matrix, may configure a screen where the application is executed, using the at least one selected resource, and may store data corresponding to the configured screen where the application is executed in the graphic memory.

In operation 470, the electronic device may control a screen output. If the external electronic device is not connected to the electronic device, the electronic device may output the screen where the application is executed on a display included in the electronic device using the data corresponding to the screen where the application is executed, stored in the graphic memory. If the external electronic device is connected to the electronic device, the electronic device may support to output the screen where the application is executed on a display included in the external electronic device by transmitting the data corresponding to the screen where the application is executed to the external electronic device, stored in the graphic memory. According to an embodiment, if the external electronic device is connected to the electronic device, while supporting to output a screen where the application is executed on the display of the external electronic device, the electronic device may output the screen where the application is executed on a display of the electronic device. In some embodiments, if the external electronic device is connected to the electronic device in a state where the screen where the application is executed is output on the display of the electronic device, the electronic device may end the output of the screen where the application is executed, output on the display of the electronic device, and may support to output the screen where the application is executed on only the display of the external electronic device.

According to an embodiment, in operation 460, the electronic device may set information of a touch region for a touch input which may occur on the screen where the application is executed, depending on whether to support a touch interface included in the application display matrix. Further, the electronic device may map the set information of the touch region to the data corresponding to the screen where the application is executed, stored in the graphic memory.

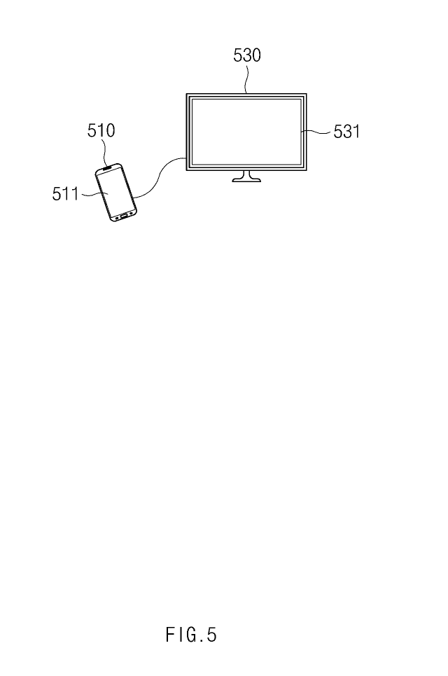

FIG. 5 illustrates a first connection form with an external electronic device according to an embodiment.

Referring to FIG. 5, an electronic device 510 (e.g., an electronic device 100 of FIG. 1) may be wiredly or wirelessly connected with an external electronic device 530 (e.g., an external electronic device 102 of FIG. 1) based on a communication interface (e.g., a communication interface 170 of FIG. 1). The electronic device 510 may support to output a screen where an application (e.g., an application 151 of FIG. 1) executed in the electronic device 510 is executed on a display 531 of the external electronic device 530.

According to an embodiment, since a characteristic of the external electronic device 530 (e.g., a size of the display 531) differs from a characteristic of the electronic device 510 (e.g., a size of a display 511), the electronic device 510 may configure a screen where the application is executed, based on characteristic information of the external electronic device 530. For example, the electronic device 510 may select at least one resource to be used by the application based on a size of the display 531 of the external electronic device 530, resolution of the display 531, a display direction of the display 531, an input processing mode of the display 531, location information of the external electronic device 530, or the like and may configure a screen where the application is executed, using the at least one selected resource. For example, if the external electronic device 530 is located in home, the electronic device 510 may select a resource which is large or high in size or resolution of an image and may configure the screen where the application is executed, using the selected resource. Alternatively, if the external electronic device 530 is located in a public place such as a company, the electronic device 510 may select a resource which is small or low in size or resolution of the image and may configure the screen where the application is executed, using the selected resource.

According to an embodiment, the electronic device 510 may select at least one resource to be used by the application based on location information of the electronic device 510 and may configure a screen where the application is executed, using the at least selected resource. For example, the electronic device 510 may select different resources if the electronic device 510 is located in home and if it is located in a public place such as a company and may configure the screen where the application is executed, using the selected resources.

According to an embodiment, the electronic device may obtain location information of the electronic device 510 or the external electronic device 530 using a global positioning system (GPS), an Internet of things (IoT) platform, or the like.

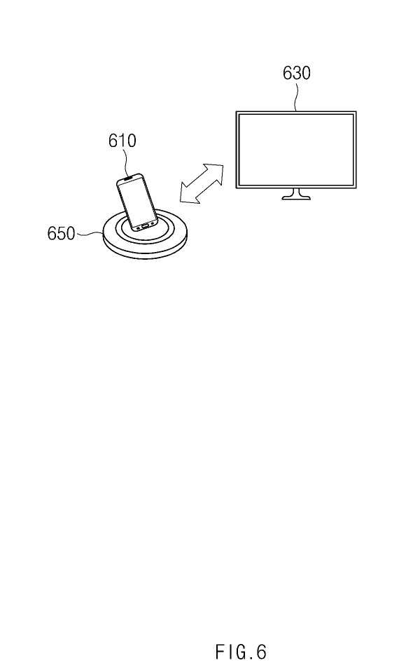

FIG. 6 illustrates a second connection form with an external electronic device according to an embodiment.

Referring to FIG. 6, an electronic device 610 (e.g., an electronic device 100 of FIG. 1) may be connected with a first external electronic device 630 via a second external electronic device 650. The second external electronic device 650 may be wiredly or wirelessly connected with the first external electronic device 630, and the electronic device 610 may be wiredly or wirelessly connected with the second external electronic device 650.

According to an embodiment, the second external electronic device 650 may store connection history information of the first external electronic device 630. The second external electronic device 650 may store an identifier, a connection start time, a connection end time, or the like of the first external electronic device 630 in a memory included in the second external electronic device 650. Further, the second external electronic device 650 may store characteristic information of the first external electronic device 630. For example, the second external electronic device 650 may store a size of a display included in the first external electronic device 630, a display direction of the display, an input processing mode of the display, location information of the first external electronic device 630, or the like. In this case, the second external electronic device 650 may map connection history information of the first external electronic device 630 with characteristic information of the first external electronic device 630 to store the mapped information.

According to an embodiment, if the electronic device 610 is connected to the second external electronic device 650, the second external electronic device 650 may transmit at least one of connection history information and characteristic information of the first external electronic device 630 to the electronic device 610. Thus, when outputting a screen where an application executed in the electronic device 610 is executed on the first external electronic device 630, the electronic device 610 may obtain characteristic information of the first external electronic device 630 from the second external electronic device 650, rather than obtaining the characteristic information of the first external electronic device 630 from the first external electronic device 630. If obtaining the characteristic information of the first external electronic device 630 from the second external electronic device 650, the electronic device 610 may verify the characteristic information of the first external electronic device 630 to be relatively faster than if obtaining the characteristic information of the first external electronic device 630 from the first external electronic device 630.

According to an embodiment, the second external electronic device 650 may maintain a state where it is always connected with the first external electronic device 630. Alternatively, the second external electronic device 650 may verify a state where it is connected with the first external electronic device 630 at intervals of a specified time to maintain a communication link with the first external electronic device 630. In some embodiments, if the second external electronic device 650 is connected with the electronic device 610, it may be connected with the first external electronic device 630.

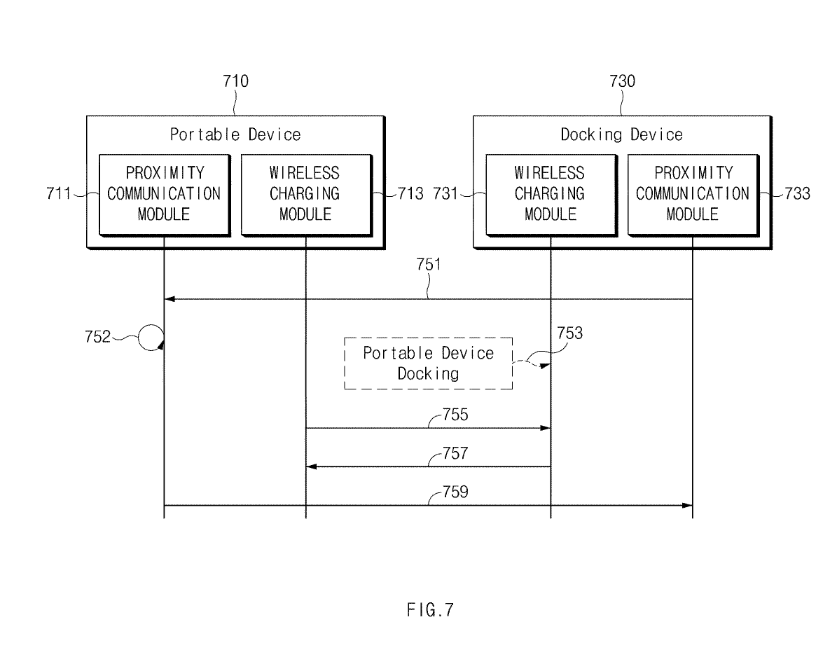

FIG. 7 illustrates a process of transmitting and receiving data with a docking device according to an embodiment.

Referring to FIG. 7, a portable device 710 (e.g., an electronic device 610 of FIG. 6) may be connected with a docking device 730 (e.g., a second external electronic device 650 of FIG. 6). The docking device 730 may support a wireless charging function. For example, if the portable device 710 is connected to the docking device 730, the docking device 730 may support to charge the portable device 710.

According to an embodiment, in operation 751, the docking device 730 may transmit a connection request signal (e.g., a ping signal) to a proximity communication module 711 included in the portable device 710 via a proximity communication module 733 included in the docking device 730. In operation 752, the portable device 710 may periodically sense whether there is a signal received via the proximity communication module 711 from the outside.

If the portable device 710 is docked (or connected) on (or with) the docking device 730 in operation 753, in operation 755, the portable device 710 may transmit a response signal (e.g., a ping acknowledge (ack) signal) to the connection request signal to a wireless charging module 731 included in the docking device 730 via a wireless charging module 713 included in the portable device 710.

If receiving the response signal, in operation 757, the docking device 730 may transmit a signal for wireless charging and information (e.g., connection history information or characteristic information) of an external electronic device (e.g., a first external electronic device 630 of FIG. 6) connected to the docking device 730 to the wireless charging module 713 of the portable device 710 via the wireless charging module 731.

If receiving the information of the external electronic device, in operation 759, the portable device 710 may select at least one resource to be used by an application, based on the information of the external electronic device, may configure a screen where the application is executed, using the at least one selected resource, and may transmit data corresponding to the screen where the application is executed to the proximity communication module 733 of the docking device 730 via the proximity communication module 711. In this case, the docking device 730 may transmit the received data corresponding to the screen where the application is executed to the external electronic device. In some embodiments, the portable device 710 may directly transmit the data corresponding to the screen where the application to the external electronic device, rather than transmitting the data to the docking device 730.

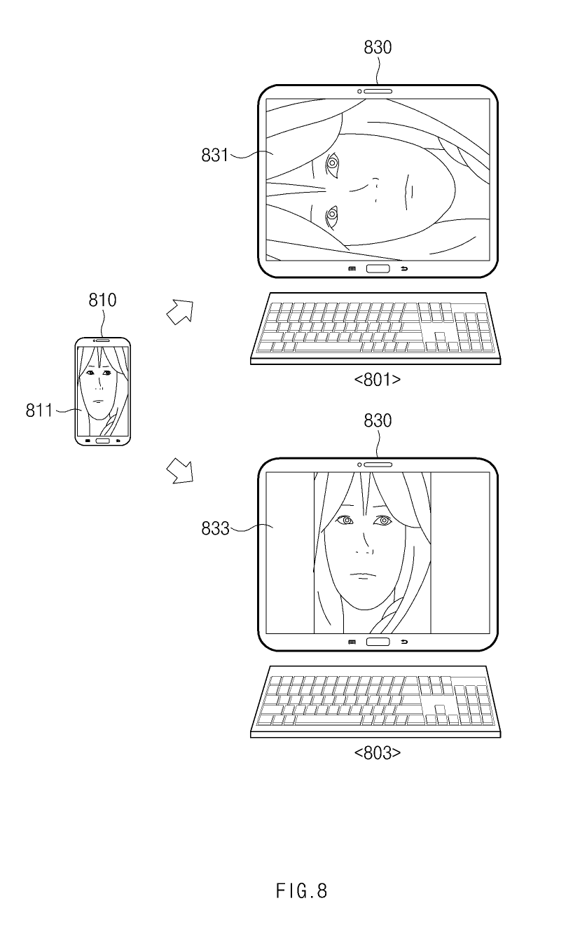

FIG. 8 illustrates a method for outputting a screen where an application with a specified display direction is executed, according to an embodiment.

Referring to FIG. 8, an electronic device 810 (e.g., an electronic device 100 of FIG. 1) may support to output a screen where an application (e.g., an application 151 of FIG. 1) is executed on an external electronic device (e.g., an external electronic device 102 of FIG. 1) based on characteristic information of the external electronic device 830 connected with the electronic device 810. As an example, the electronic device 810 may output a screen 811 where an application is executed, configured using a first resource (e.g., a first image of a portrait direction). The external electronic device 830 may output a screen 831 where an application is executed, configured using a second resource (e.g., a second image of a landscape direction), in a first state 801.

According to an embodiment, if the application supports only a specified display direction, the electronic device 810 may configure a screen where the application is executed, based on the display direction supported by the application as well as characteristic information of the external electronic device 830. For example, if the application supports only a portrait direction, the electronic device 810 may configure a screen 833 where the application is executed, using a third resource (e.g., a third image of the portrait direction) in a second state 803.

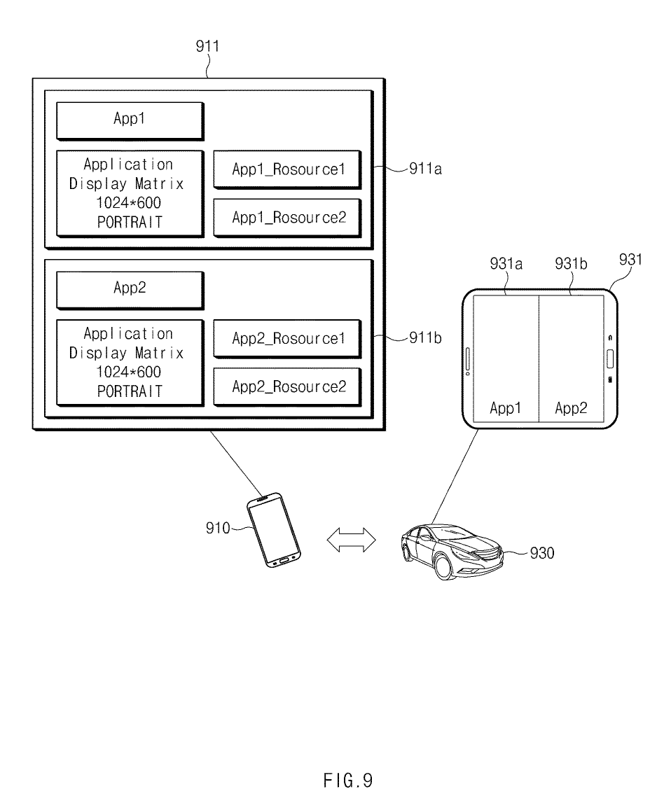

FIG. 9 illustrates a method for outputting a screen where a plurality of applications are executed, according to an embodiment.

Referring to FIG. 9, an electronic device 910 (e.g., an electronic device 100 of FIG. 1) may execute a plurality of applications. The electronic device 910 may execute a first application 911a and a second application 911b stored in a memory 911 (e.g., a memory 150 of FIG. 1). Further, the electronic device 910 may output a screen where the first application 911a is executed and a screen where the second application 911b is executed together through a multi-window function.

According to an embodiment, the electronic device 910 may support to output a screen where the plurality of applications executed in the electronic device 910 are executed, on an external electronic device 930 connected with the electronic device 910. If the plurality of applications are executed through the multi-window function, the electronic device 910 may generate one screen configured with a multi-window format based on characteristic information of the external electronic device 930 and an application display matrix included in each of the plurality of applications. The electronic device 910 may transmit data corresponding to the generated one screen to the external electronic device 930, thus supporting to output a screen configured with the multi-window format on a display 931 included in the external electronic device 930.

In some embodiments, the electronic device 910 may generate a screen where each of the plurality of applications is executed, based on characteristic information of the external electronic device 930 and an application display matrix included in each of the plurality of applications. The electronic device 910 may support to output the screen where each of the plurality of applications is executed on the display 931 included in the external electronic device 930 by transmitting data corresponding to the screen where each of the plurality of applications is executed to the external electronic device 930. In this case, the external electronic device 930 may divide a screen region of the display 931 to output the screen where each of the plurality of applications is executed, in the multi-window format and may output the screen where each of the plurality of applications is executed on each of the divided screen regions. The external electronic device 930 may divide the screen region of the display 931 to correspond to a rate of screen regions included in a multi-window of the electronic device 910. As illustrated, the external electronic device 930 may output a screen where the first application 911a is executed on a first screen region 931a and may output a screen where the second application 911b is executed on a second screen region 931b.

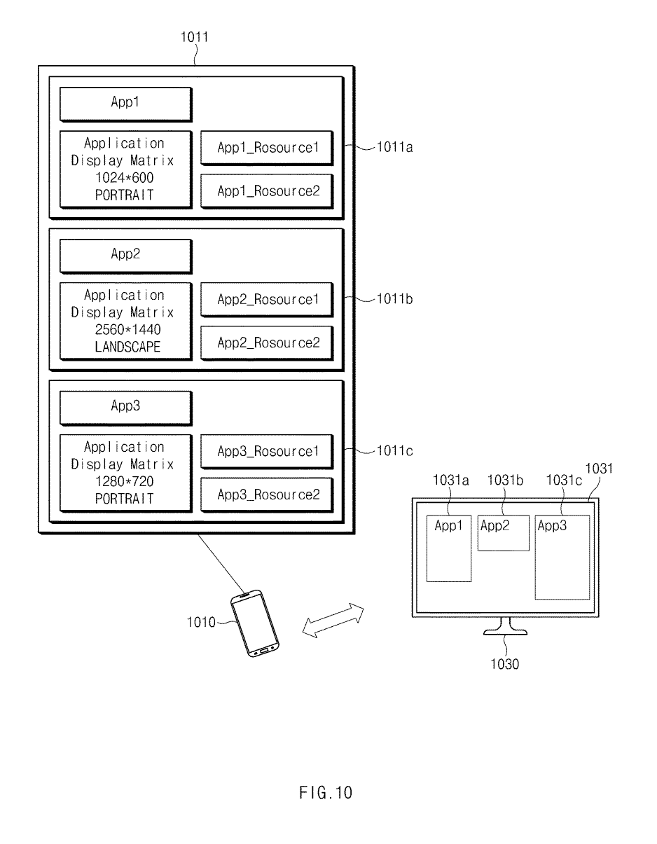

FIG. 10 illustrates another method for outputting a screen where a plurality of applications are executed, according to an embodiment.

Referring to FIG. 10, an electronic device 1010 (e.g., an electronic device 100 of FIG. 1) may execute a plurality of applications. The electronic device 1010 may execute a first application 1011a, a second application 1011b, and a third application 1011c stored in a memory 1011 (e.g., a memory 150 of FIG. 1). Further, at least one application executed in the electronic device 1010 may maintain the executed state in the background. In this case, the electronic device 1010 may output only a screen where an application which is being executed in the foreground is executed, on a display included in the electronic device 1010.

According to an embodiment, the electronic device 1010 may support to output a screen where the plurality of applications executed in the electronic device 1010 are executed, on an external electronic device 1030 connected with the electronic device 1010. If at least one of the plurality of applications is being executed in the background, the electronic device 1010 may support to output only a screen where an application which is being executed in the foreground is executed, on a display 1031 included in the external electronic device 1030.

In some embodiments, although an application is being executed in the background, the electronic device 1010 may support to output a screen where the application is executed, on the display 1031 included in the external electronic device 1030. For example, if the display 1031 included in the external electronic device 1030 is relatively larger in size than the display included in the electronic device 1010 or if the display 1031 included in the external electronic device 1030 is relatively higher in solution than the display included in the electronic device 1010, the electronic device 1010 may support to output a screen where the plurality of applications executed in the electronic device 1010 are executed, on the display 1031 of the external electronic device 1030. As illustrated, the external electronic device 1030 may output a screen 1031a where the first application 1011a is executed, a screen 1031b where the second application 1011b is executed, and a screen 1031c where the third application 1011c is executed, together on the display 1031. According to an embodiment, the external electronic device 1030 may analyze a screen region occupied by the screens where the plurality of applications are executed and may determine layout of the screens where the plurality of application are executed, based on the analyzed result.

As described above, according to various embodiments, an electronic device (e.g., the electronic device 100) may include a memory (e.g., the memory 150) configured to store an application (e.g., the application 151) including a plurality of resources (e.g., the first resource 153 and the second resource 155), each of the resources is matched to each of a plurality of characteristic information which include a first characteristic information of the electronic device and a second characteristic information of an external electronic device, a communication interface (e.g., the communication interface 170) configured to communicate with the external electronic device (e.g., the external electronic device 102), and a processor (e.g., the processor 110) configured to be operatively connected with the memory and the communication interface. The processor may be configured to obtain the second characteristic information of the external electronic device connected via the communication interface, select at least one of the resources included in the application based on the second characteristic information of the external electronic device, generate a screen where the application is executed, using the at least one of the resources, and transmit data corresponding to the screen to the external electronic device.

According to various embodiments, the plurality of resources may comprise at least one of a plurality of images, which vary in at least one of size and resolution, and layout information of the plurality of images.

According to various embodiments, the second characteristic information of the external electronic device may comprise at least one of a size of a display included in the external electronic device, resolution of the display, a display direction of the display, an input processing mode of the display, and location information of the external electronic device.

According to various embodiments, the processor may be configured to store the second characteristic information of the external electronic device in the memory.

According to various embodiments, the processor may be configured to obtain the second characteristic information of the external electronic device from the external electronic device via the communication interface if the second characteristic information of the external electronic device is not stored in the memory, and use the second characteristic information of the external electronic device if the second characteristic information of the external electronic device is stored in the memory, the second characteristic information being stored in the memory.

According to various embodiments, the processor may be configured to obtain the second characteristic information of the external electronic device from another external electronic device connected with the external electronic device.

According to various embodiments, the processor may be configured to select at least one of the resources included in the application based on the second characteristic information of the external electronic device and a designated display direction if the application supports the designated display direction.

According to various embodiments, the memory may store a plurality of applications respectively including the plurality of resources, and the processor may be configured to generate the screen configured with a multi-window format using the at least one of the resources selected from each of the applications based on the second characteristic information of the external electronic device, and transmit data corresponding to the screen to the external electronic device.

According to various embodiments, the memory may store a plurality of applications respectively including the plurality of resources, and the processor may be configured to generate a plurality of screens using the at least one of the resources selected from each of the applications based on the second characteristic information of the external electronic device, the screens being included in the screen configured with a multi-window format, and transmit data corresponding to the screens to the external electronic device.

According to various embodiments, the memory may store a plurality of applications respectively including the plurality of, and the processor may be configured to generate a plurality of screens using the at least one of the resources selected from each of the applications based on the second characteristic information of the external electronic device if at least one of the applications is being executed in the background state, and transmit data corresponding to the screens to the external electronic device.

As described above, according to various embodiments, a method for controlling a screen of an electronic device including an application including a plurality of resources, each of the resources is matched to each of a plurality of characteristic information which include a first characteristic information of the electronic device and a second characteristic information of an external electronic device, the method may include obtaining the second characteristic information of the external electronic device connected to the electronic device, selecting at least one of the resources included in the application based on the second characteristic information of the external electronic device, generating a screen where the application is executed, using the at least one of the resources, and transmitting data corresponding to the screen to the external electronic device.

According to various embodiments, the obtaining of the second characteristic information of the external electronic device may include obtaining at least one of a size of a display included in the external electronic device, resolution of the display, a display direction of the display, an input processing mode of the display, and location information of the external electronic device.

According to various embodiments, the method may further include storing the second characteristic information of the external electronic device in a memory included in the electronic device.

According to various embodiments, the obtaining of the second characteristic information of the external electronic device may include obtaining the second characteristic information of the external electronic device from the external electronic device via a communication interface included in the electronic device if the second characteristic information of the external electronic device is not stored in a memory included in the electronic device, and using the second characteristic information of the external electronic device, the second characteristic information being stored in the memory if the second characteristic information of the external electronic device is stored in the memory.

According to various embodiments, the obtaining of the second characteristic information of the external electronic device may include obtaining the second characteristic information of the external electronic device from another external electronic device connected with the external electronic device.

According to embodiments described in the present disclosure, the electronic device may output a screen where the application installed in the electronic device is executed to fit characteristics of the external electronic device when outputting the screen where the application is executed, via the external electronic device.

In addition, the electronic device may provide a variety of effects directly or indirectly ascertained through the present disclosure.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 110), the processor may perform functions corresponding to the instructions. The computer-readable storage medium may be, for example, the memory 150.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a memory configured to store an application including a plurality of resources, each of the resources is matched to each of a plurality of characteristic information which includes a first characteristic information of the electronic device and a second characteristic information of an external electronic device;
a communication interface configured to communicate with the external electronic device; and
a processor configured to be operatively connected with the memory and the communication interface,
wherein the processor is configured to:
receive the second characteristic information of the external electronic device connected via the communication interface;
select at least one of the resources included in the application based on the second characteristic information of the external electronic device;
generate a screen where the application is executed using the at least one of the resources; and
transmit data corresponding to the screen to the external electronic device.

2. The electronic device of claim 1, wherein the plurality of resources comprise at least one of a plurality of images that vary in at least one of size and resolution and layout information of the plurality of images.

3. The electronic device of claim 1, wherein the second characteristic information of the external electronic device comprises at least one of a size of a display included in the external electronic device, resolution of the display, a display direction of the display, an input processing mode of the display, or location information of the external electronic device.

4. The electronic device of claim 1, wherein the processor is configured to store the second characteristic information of the external electronic device in the memory.

5. The electronic device of claim 4, wherein the processor is configured to:
if the second characteristic information of the external electronic device is not stored in the memory, receive the second characteristic information of the external electronic device from the external electronic device via the communication interface; and
if the second characteristic information of the external electronic device is stored in the memory, use the second characteristic information of the external electronic device.

6. The electronic device of claim 1, wherein the processor is configured to receive the second characteristic information of the external electronic device from another external electronic device connected with the external electronic device.

7. The electronic device of claim 1, wherein the processor is configured to:
if the application supports a designated display direction, select at least one of the resources included in the application based on the second characteristic information of the external electronic device and the designated display direction.

8. The electronic device of claim 1, wherein the memory stores a plurality of applications including the plurality of resources, and
wherein the processor is configured to:
generate the screen configured with a multi-window format using the at least one of the resources selected from each of the applications based on the second characteristic information of the external electronic device; and
transmit data corresponding to the screen to the external electronic device.

9. The electronic device of claim 1, wherein the memory stores a plurality of applications including the plurality of resources, and
wherein the processor is configured to:
generate a plurality of screens using the at least one of the resources selected from each of the applications based on the second characteristic information of the external electronic device, the screens being included in the screen configured with a multi-window format; and
transmit data corresponding to the screens to the external electronic device.

10. The electronic device of claim 1, wherein the memory stores a plurality of applications including the plurality of, and
wherein the processor is configured to:
if at least one of the applications is being executed in a background state, generate a plurality of screens using the at least one of the resources selected from each of the applications based on the second characteristic information of the external electronic device; and
transmit data corresponding to the screens to the external electronic device.

11. A method for controlling a screen of an electronic device including an application including a plurality of resources, each of the resources is matched to each of a plurality of characteristic information which includes a first characteristic information of the electronic device and a second characteristic information of an external electronic device, the method comprising:
receiving the second characteristic information of the external electronic device connected to the electronic device;
selecting at least one of the resources included in the application based on the second characteristic information of the external electronic device;
generating a screen where the application is executed, using the at least one of the resources; and
transmitting data corresponding to the screen to the external electronic device.

12. The method of claim 11, wherein the receiving of the second characteristic information of the external electronic device comprises:
receiving at least one of a size of a display included in the external electronic device, resolution of the display, a display direction of the display, an input processing mode of the display, or location information of the external electronic device.

13. The method of claim 11, further comprising:
storing the second characteristic information of the external electronic device in a memory included in the electronic device.

14. The method of claim 11, wherein the receiving of the second characteristic information of the external electronic device comprises:
if the second characteristic information of the external electronic device is not stored in a memory included in the electronic device, receiving the second characteristic information of the external electronic device from the external electronic device via a communication interface included in the electronic device; and
if the second characteristic information of the external electronic device is stored in the memory, using the second characteristic information of the external electronic device.

15. The method of claim 11, wherein the receiving of the second characteristic information of the external electronic device comprises receiving the second characteristic information of the external electronic device from another external electronic device connected with the external electronic device.

16. A non-transitory computer readable medium embodying a computer program, the computer program comprising computer readable program code that when executed causes at least one processing device to:
receive a second characteristic information of an external electronic device connected to an electronic device;
select at least one resource included in an application based on the second characteristic information of the external electronic device;
generate a screen where the application is executed using the at least one resource; and
transmit data corresponding to the screen to the external electronic device.

17. The non-transitory computer readable medium of claim 16, wherein the receiving of the second characteristic information of the external electronic device comprises:
receiving at least one of a size of a display included in the external electronic device, resolution of the display, a display direction of the display, an input processing mode of the display, or location information of the external electronic device.

18. The non-transitory computer readable medium of claim 16, wherein the computer readable program code causes the at least one processing device to store the second characteristic information of the external electronic device in a memory included in the electronic device.

19. The non-transitory computer readable medium of claim 16, wherein the receiving of the second characteristic information of the external electronic device comprises:
if the second characteristic information of the external electronic device is not stored in a memory included in the electronic device, receiving the second characteristic information of the external electronic device from the external electronic device via a communication interface included in the electronic device; and
if the second characteristic information of the external electronic device is stored in the memory, using the second characteristic information of the external electronic device.

20. The non-transitory computer readable medium of claim 16, wherein the receiving of the second characteristic information of the external electronic device comprises receiving the second characteristic information of the external electronic device from another external electronic device connected with the external electronic device.
